(19) United States
(12) Patent Application Publication
(10) Pub. No.: US 2012/0144384 A1
(43) Pub. Date: Jun. 7, 2012

(54) SYSTEM AND METHOD FOR PROVIDING SERVICE INFORMATION CORRESPONDING TO MOBILE APPLICATION ANALYSIS

(76) Inventor: Dong Houn BAEK, Seoul (KR)

(21) Appl. No.: 13/271,206

(22) Filed: Oct. 11, 2011

(30) Foreign Application Priority Data
Dec. 7, 2010 (KR) 10-2010-0124434

(51) Int. Cl. G06F 9/44; G06F 15/16

(52) U.S. Cl. 717/173; 709/224

(57) ABSTRACT

A system and method for providing service information corresponding to mobile application analysis. The system includes an application insertion module stored in a device previously distributed and installed, and configured to extract a plurality of pieces of log data generated by execution of an application of the device, transmit the pieces of extracted log data to an analysis server over a wireless communication network, and execute application service information. The analysis server is configured to receive the pieces of log data from the application insertion module, extract usage patterns, execution function usage frequency, and device information of the application, which are contained in the log data, display analysis results of respective log data lists, and transmit pieces of application service information, which are generated to conform to the analysis results of the respective log data lists, to the application insertion module.

This application claims priority under USC §119 to Korean Patent Application No. 10-2010-0124434 filed Dec. 7, 2010, which is incorporated herein in its entirety.

### BACKGROUND OF THE INVENTION

1. Field of the Invention

The present invention relates, in general, to an apparatus and method for providing service information corresponding to mobile application analysis and, more particularly, to technology that analyzes the usage patterns, user behavior, device information and analysis reports of consumers on the basis of log data, which is generated by the execution of a mobile application provided on a device, and provides service information to a targeted device or a targeted application based on the results of the analysis.

2. Description of the Related Art

With the rapid development of electronic and communication technology, various types of mobile communication services, such as a wireless voice call service, a message service, and a wireless Internet service, have been provided over a mobile communication network. As various types of mobile communication services have been provided, mobile terminals, such as mobile phones, Personal Digital Assistants (PDAs), Portable Multimedia Players (PMPs), Ultra-Mobile Person Computers (UMPCs), and notebook computers, have established themselves as one of necessary articles that are carried by many people at all times and everywhere they go.

On such a mobile terminal, an operating system and a platform for communicating with a mobile communication system are installed. Such an operating system and a platform are selected and installed by a microprocessor manufacturer, a mobile terminal manufacturer, or a mobile communication service provider. In addition, various types of mobile applications running on the platform are also supplied by a mobile communication service provider or a mobile terminal manufacturer.

However, since subjects that manage an operating system, a platform, and a mobile application are limited to a microprocessor manufacturer, a mobile terminal manufacturer, or a mobile communication service provider, the users of mobile terminal cannot execute mobile applications, other than those specific mobile applications provided by the mobile communication service provider or the mobile terminal manufacturer, on their mobile terminals, and thus the use of mobile terminals is limited.

Accordingly, mobile terminals have recently been released on which users can install their own mobile applications. Furthermore, mobile terminals allowing the users to download various desired mobile applications from mobile application stores and to run the downloaded mobile applications on their mobile terminals have been released.

However, since mobile application providers cannot gain a precise understanding of how the mobile applications they developed and distributed or sold are being used, they cannot check improvement or market conditions related to mobile applications which will be released in the future.

That is, there are problems in that it cannot be determined which type of users are using a mobile application released by a relevant mobile application provider, how the mobile application is being used, how many users are actually using the mobile application, how many times a day the mobile application is being used, how long the mobile application is being used, which area the mobile application is being widely used in, and which function is most popularly used.

### SUMMARY OF THE INVENTION

Accordingly, the present invention has been made keeping in mind the above problems occurring in the prior art, and an object of the present invention is to provide an apparatus and method for providing service information, which extracts log data generated by the execution of distributed mobile applications, analyzes the usage patterns, user behavior, device information and analysis reports of consumers, and performs targeting classification of the distributed mobile applications, thus providing required service information (information about coupons for respective regions to which devices are connected, information about the re-installation of an upgraded application, information about charging fees for a relevant application, messages inviting the reuse of a relevant application, or information about discount coupons of stores adjacent to a region which is frequently connected) to each device or application in the form of a pop-up or push notification.

In order to accomplish the above object, the present invention provides a system for providing service information corresponding to mobile application analysis, including an application insertion module stored in a device previously distributed and installed, and configured to extract a plurality of pieces of log data generated by execution of an application of the device, transmit the pieces of extracted log data to an analysis server over a wireless communication network, and execute application service information received from the analysis server; and the analysis server configured to receive the pieces of log data from the application insertion module, extract usage patterns, execution function usage frequency, and device information of the application, which are contained in the log data, display analysis results of respective log data lists, and transmit pieces of application service information, which are generated to conform to the analysis results of the respective log data lists, to the application insertion module installed in the device.

Further, a method of providing service information corresponding to mobile application analysis according to the present invention, based on the above-described system, includes (a) an application insertion module extracting log data generated by execution of an application installed on a device, and transmitting the extracted log data to an analysis server over a wireless communication network; (b) the analysis server extracting usage patterns, execution function usage frequency, and device information of the application, which are contained in the received log data, and then displaying analysis results of respective log data lists; (c) the analysis server transmitting pieces of application service information, which are generated to conform to the analysis results of respective log data lists, to the application insertion module installed in the device over the wireless communication network in a form of a pop-up or push notification; and (d) the application insertion module executing the application service information received from the analysis server.

### BRIEF DESCRIPTION OF THE DRAWINGS

FIG. 1 is a diagram showing the construction of an apparatus for providing service information corresponding to mobile application analysis according to the present invention;

FIG. 2 is a diagram showing the detailed construction of the application of the system for providing service information corresponding to mobile application analysis according to the present invention;

FIG. 3 is a diagram showing a relationship between the components of the application of the system for providing service information corresponding, to mobile application analysis according to the present invention;

FIG. 4 is a diagram showing the detailed construction of the analysis server of the system for providing service information corresponding to mobile application analysis according to the present invention;

FIG. 5 is a diagram illustrating log data analyzed by the analysis server of the system for providing service information corresponding to mobile application analysis according to the present invention;

FIG. 6 is a diagram illustrating log data usage pattern information generated by the analysis server of the system for providing service information corresponding to mobile application analysis according to the present invention;

FIG. 7 is a diagram illustrating another piece of log data usage pattern information generated by the analysis server of the system for providing service information corresponding to mobile application analysis according to the present invention;

FIG. 8 is a diagram illustrating log data device information generated by the analysis server of the system for providing service information corresponding to mobile application analysis according to the present invention;

FIG. 9 is a first diagram illustrating application service information generated by the analysis server of the system for providing service information corresponding to mobile application analysis according to the present invention;

FIG. 10 is a second diagram illustrating application service information generated by the analysis server of the system for providing service information corresponding to mobile application analysis according to the present invention;

FIG. 11 is a third diagram illustrating application service information generated by the analysis server of the system for providing service information corresponding to mobile application analysis according to the present invention;

FIG. 12 is a fourth diagram illustrating application service information generated by the analysis server of the system for providing service information corresponding to mobile application analysis according to the present invention;

FIG. 13 is a fifth diagram illustrating application service information generated by the analysis server of the system for providing service information corresponding to mobile application analysis according to the present invention;

FIG. 14 is a diagram illustrating an example in which the application service information of the system for providing service information corresponding to mobile application analysis according to the present invention is transmitted to the application of all devices or a specific target device according to the manipulation of a manager;

FIG. 15 is a flowchart showing a method of providing service information corresponding to mobile application analysis according to the present invention;

FIG. 16 is a flowchart showing the detailed procedure of step S20 of the method of providing service information corresponding to mobile application analysis according to the present invention; and

FIG. 17 is a flowchart showing the detailed procedure of step S30 of the method of providing service information corresponding to mobile application analysis according to the present invention.

### DESCRIPTION OF THE PREFERRED EMBODIMENTS

The above and other objects, features and advantages of the present invention will be more clearly understood from the following detailed description taken in conjunction with the accompanying drawings. The terms and words used in the present specification and the accompanying claims should not be limitedly interpreted as having their common meanings or those found in dictionaries, but should be interpreted as having meanings adapted to the technical spirit of the present invention on the basis of the principle that an inventor can appropriately define the concepts of terms in order to best describe his or her invention. Further, if in the specification, detailed descriptions of well-known functions or configurations may unnecessarily make the gist of the present invention obscure, the detailed descriptions will be omitted.

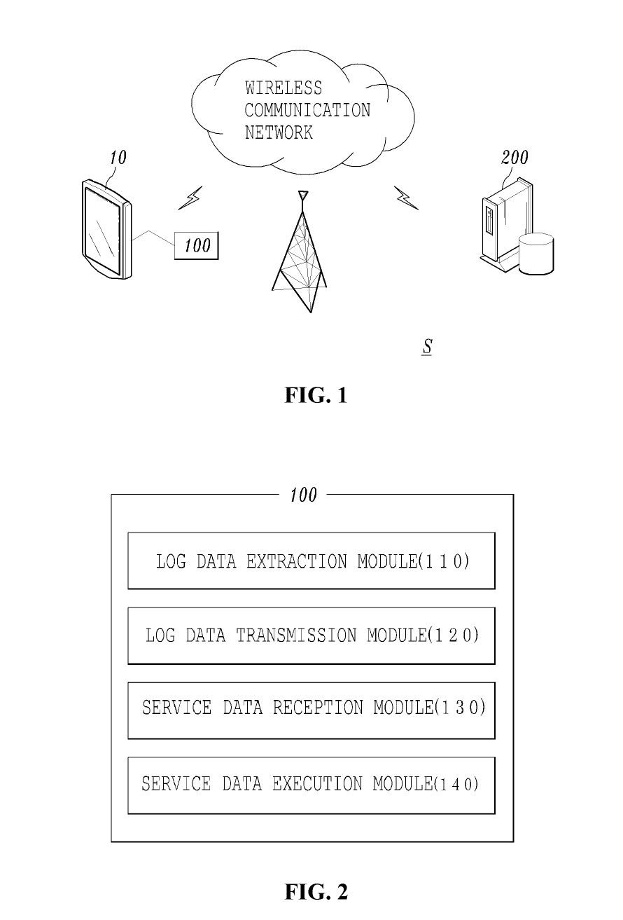

As shown in FIG. 1, a system S for providing service information corresponding to mobile application analysis according to the present invention includes an application insertion module 100 and an analysis server 200.

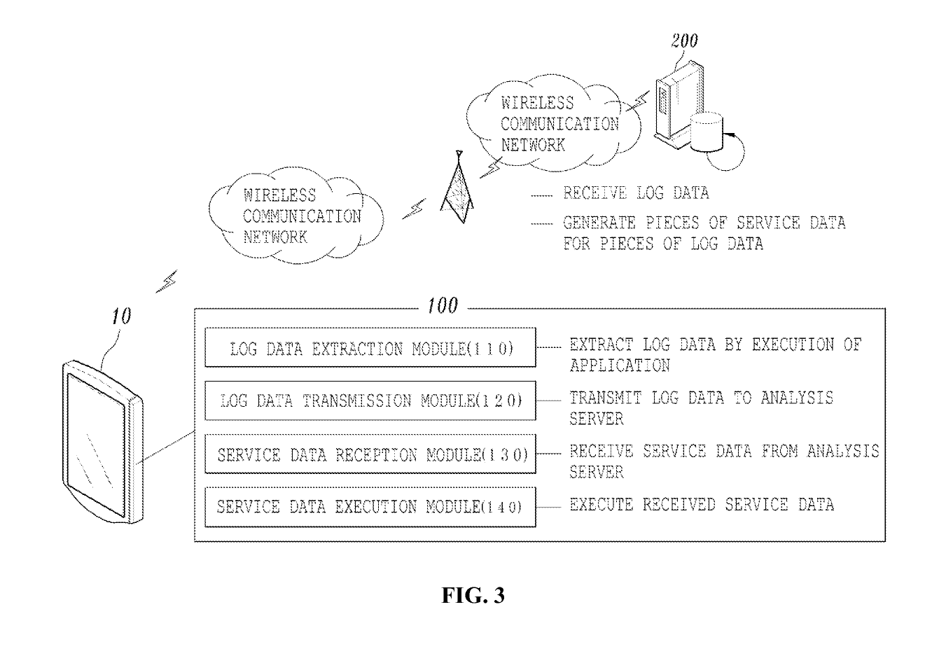

Referring to FIG. 2, the application insertion module 100 is stored in a device 10, which has been previously distributed and installed, and is configured to function to extract log data generated by the execution of the application of the device 10, transmit the log data to the analysis server 200 over a wireless communication network, and execute application service information received from the analysis server 200. In this regard, the application insertion module 100 includes a log data extraction module 110, a log data transmission module 120, a service data reception module 130, and a service data execution module 140.

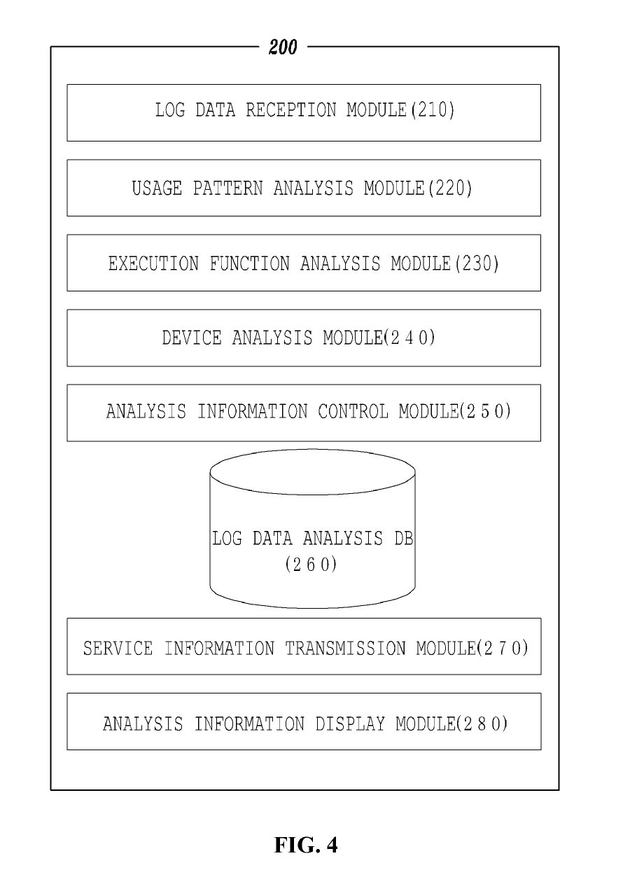

Hereinafter, a relationship between the components of the application insertion module 100 of the system S for providing service information corresponding to mobile application analysis according to the present invention will be described in detail with reference to FIG. 3.

In detail, the log data extraction module 110 of the application insertion module 100 extracts pieces of log data generated in real time as the application of the device 10 is executed. The log data transmission module 120 transmits the pieces of extracted log data to the preset analysis server 200 over a wireless communication network.

Further, the service data reception module 130 receives the application service information from the analysis server 200 over the wireless communication network in the form of any one of pop-up and push notifications.

Furthermore, the service data execution module 140 executes the application service information and then updates the previously installed application under the control of the device 10.

In this case, it is preferably understood that an “update of the previously installed application” upgrades the version of the application previously installed on the device 10, provides notification of error information about the application, provides information about a newly released application, or installs or displays pieces of information about the provision of coupons for the respective areas to which the device 10 is connected, but the present invention is not limited thereto.

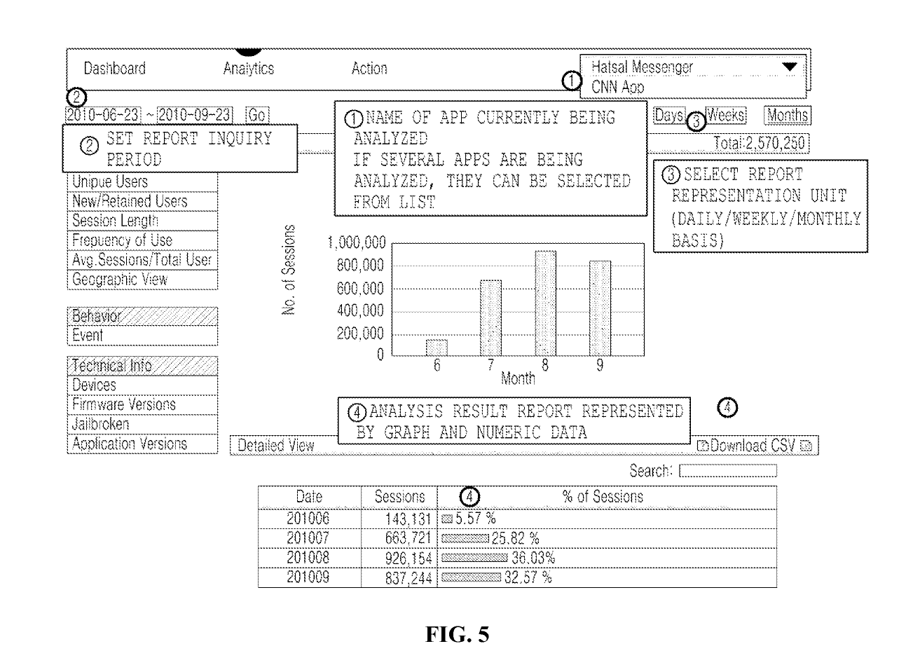

Hereinafter, the analysis server 200 of the system S for providing service information corresponding to mobile application analysis according to the present invention will be described in detail with reference to FIG. 4.

The analysis server 200 functions to receive a plurality of pieces of log data from the log data transmission module 120 included in the application insertion module 100 over the wireless communication network, to extract pieces of information about the usage pattern, execution function usage frequency, and device information of the application, included in the log data, and display the results of the analysis of respective log data lists, as shown in FIG. 5. Further, the analysis server also functions to transmit pieces of application service information, generated to conform to the analysis results of the respective log data lists, to the device 10 in which the application insertion module 100 is installed. The analysis server 200 includes a log data reception module 210, a usage pattern analysis module 220, an execution function analysis module 230, a device analysis module 240, an analysis information control module 250, a log data analysis database (DB) 260, a service information transmission module 270, and an analysis information display module 280.

In detail, the log data reception module 210 of the analysis server 200 receives pieces of log data over the wireless communication network either in real time or according to the schedule of the application insertion module 100.

Further, the usage pattern analysis module 220 generates log data usage pattern information by analyzing usage patterns included in the pieces of log data received from the log data reception module 210, and stores the generated log data usage pattern information in the log data analysis DB 260.

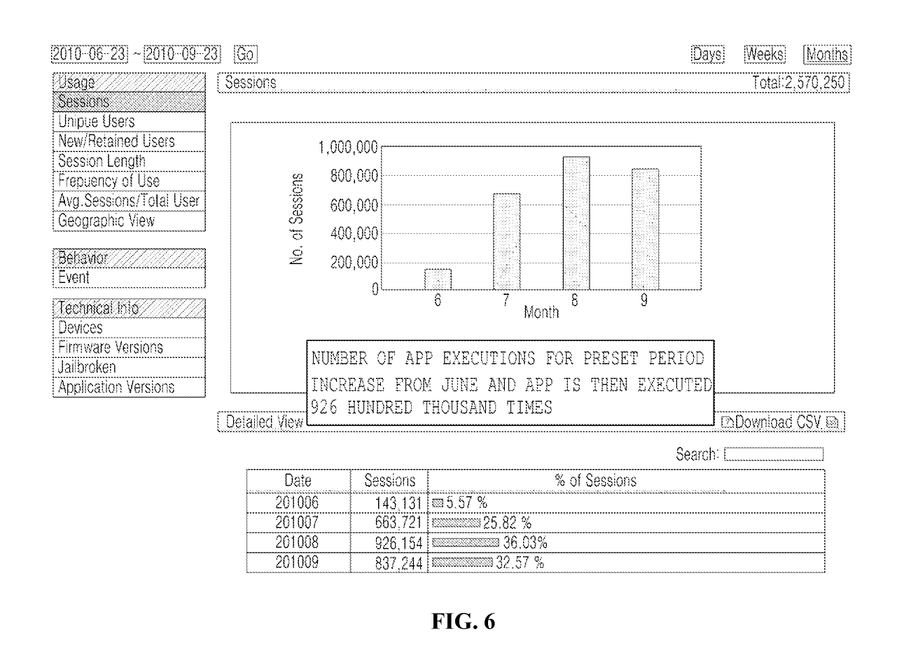

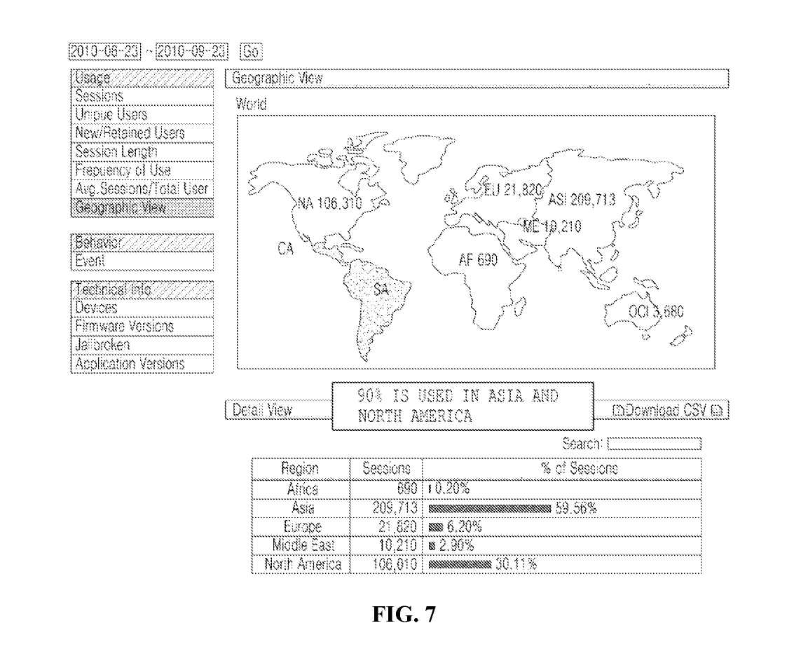

In this case, as shown in FIGS. 6 and 7, the log data usage pattern information includes at least one of information about the count of the number of executions of the application insertion module 100, information about the count of users obtained by eliminating the number of duplicated executions based on date, information about the count of new users, information about the count of retained users, information about usage frequency based on the number of executions of the application insertion module 100, information about the count of the average number of executions for each unique user, and information about region-based user distributions.

Further, the execution function analysis module 230 generates log data execution function information by analyzing the details of the execution of functions or menus that are performed by the application insertion module 100 and are included in the log data received from the log data reception module 210, and stores the generated log data execution function information in the log data analysis DB 260.

In this case, the log data execution function information contains information about the count of the number of executions of the application insertion module 100 for each menu, and data that has changed as the application insertion module 100 installed in the device 10 is executed.

Further, the device analysis module 240 generates log data device information by analyzing pieces of device data contained in the respective pieces of log data received from the log data reception module 210, and stores the generated log data device information in the log data analysis DB 260.

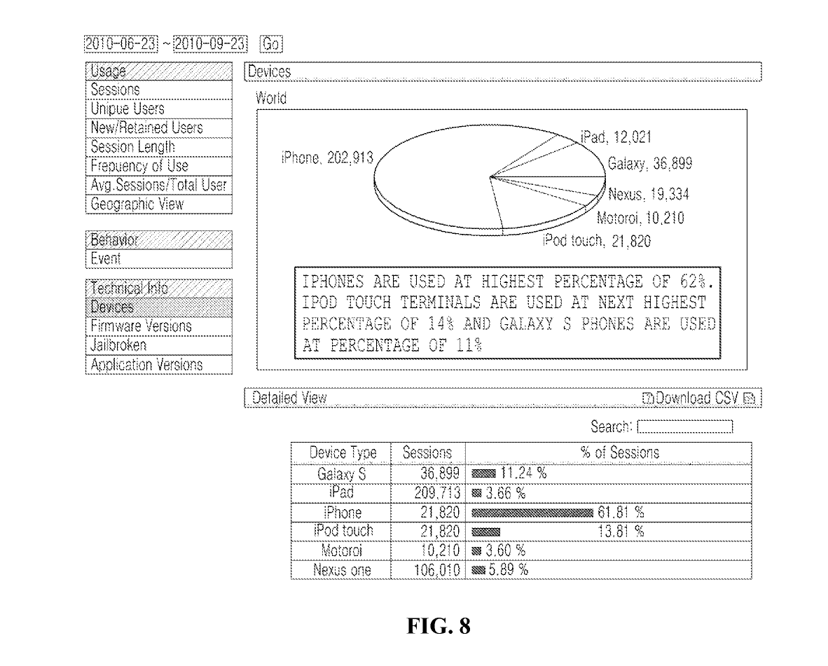

In this case, as shown in FIG. 8, the log data device information includes any one of information about the count of the number of model-based devices 10, in which the application insertion module 100 is installed, framework information about an operating system installed to operate the devices 10, information about the count of version-based application insertion modules 100 installed in the devices 10, and information about the count of models, for which the security of the operating system of the application insertion module 100 is released and jailbroken, for each device 10.

Further, the analysis information control module 250 generates the pieces of application service information corresponding to the analysis results of the respective log data lists by combining the log data usage pattern information, the log data execution function information, and the log data device information respectively received from the usage pattern analysis module 220, the execution function analysis module 230, and the device analysis module 240.

Here, the application service information includes information required to upgrade the version of the application previously installed on the device 10, information required to provide notification of error information about the application, information about the details of a newly released application, or information about the provision of coupons for respective regions to which the device 10 on which the application insertion module 100 is executed is connected.

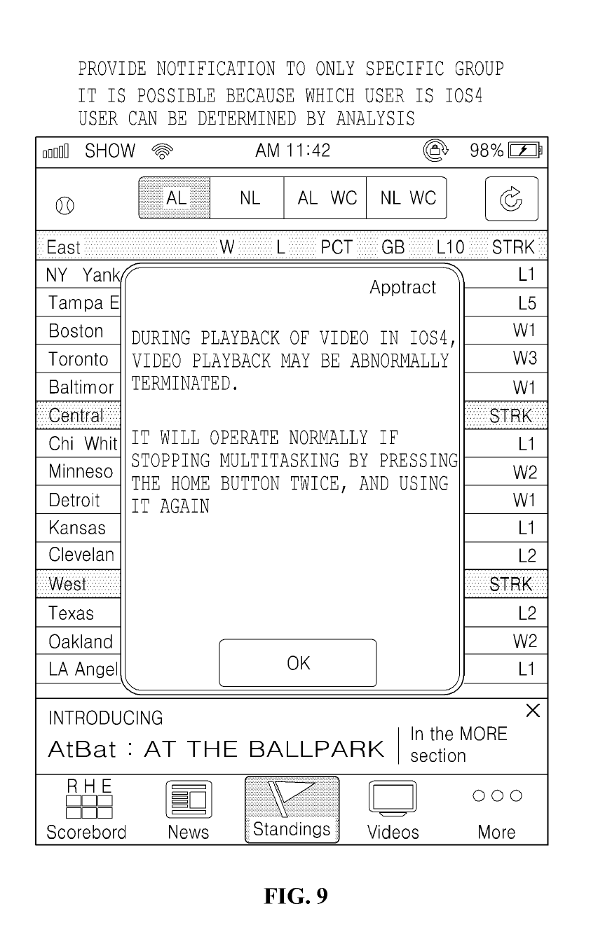

For example, as shown in FIG. 9, the application service information may be information required to make compensation for errors or collisions and to reinstall an upgraded application if errors occur on the execution of a relevant application or if collisions with other applications are present, as a result of having analyzed the log data of the previously installed application insertion module 100.

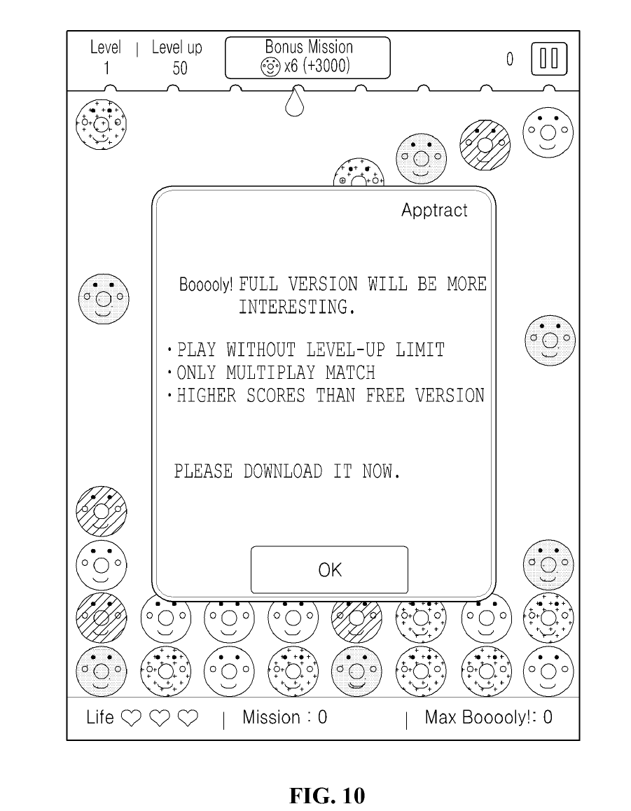

Further, as shown in FIG. 10, the application service information may be information required to charge fees for the installed application if the loyalty of the device 10 based on the frequency of execution is high, as a result of having analyzed the log data of the previously installed application insertion module 100.

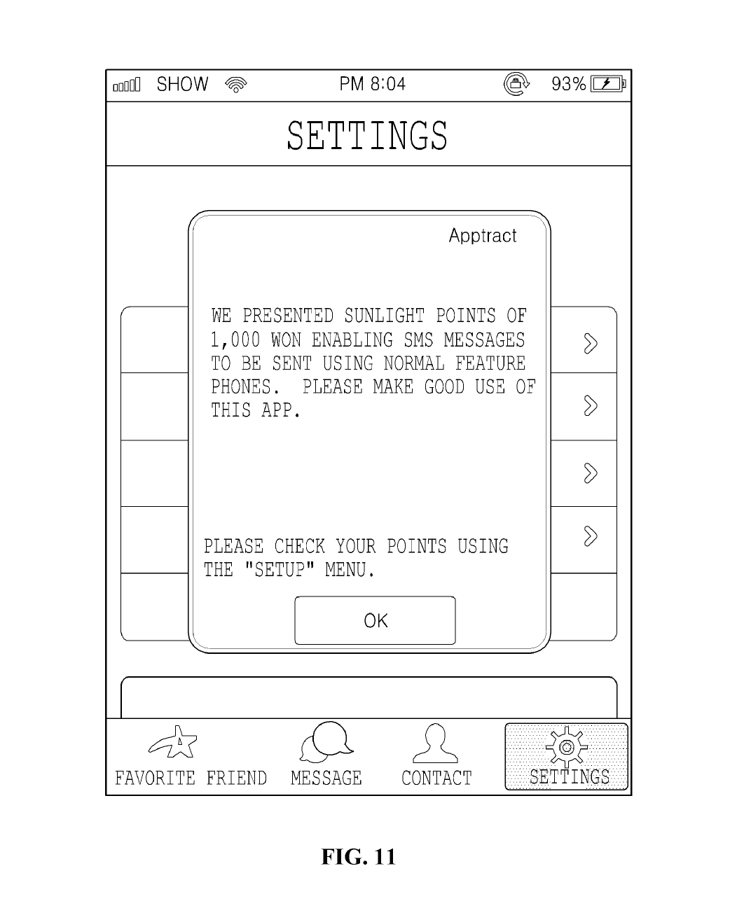

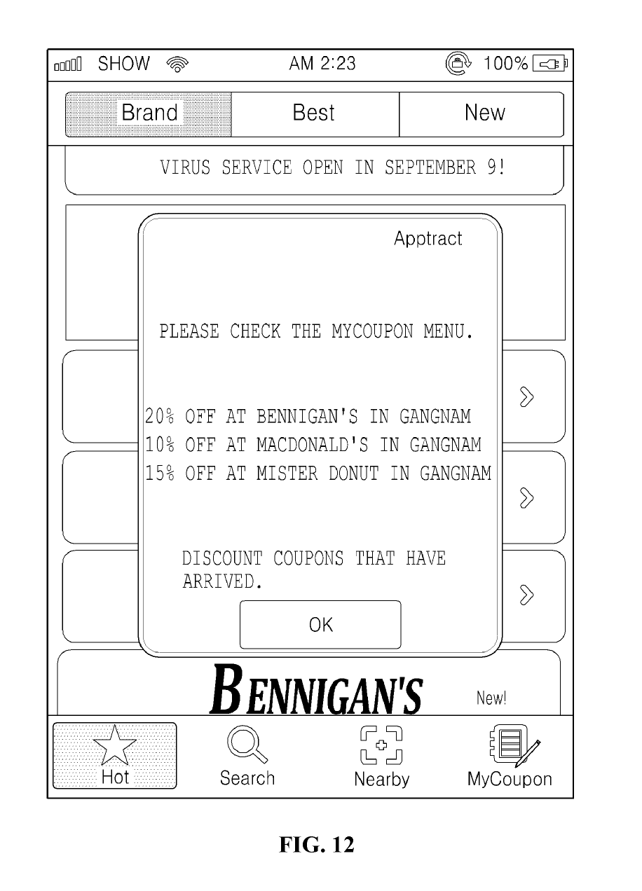

Furthermore, as shown in FIG. 11, the application service information may be information required to invite a device 10 having low loyalty based on the frequency of execution to be reused as a result of having analyzed the log data of the previously installed application insertion module 100. Furthermore, as shown in FIG. 12, the application service information may be information including discount coupons for stores adjacent to a region to which the device 10 is frequently connected, as a result of having analyzed the log data of the previously installed application insertion module 100.

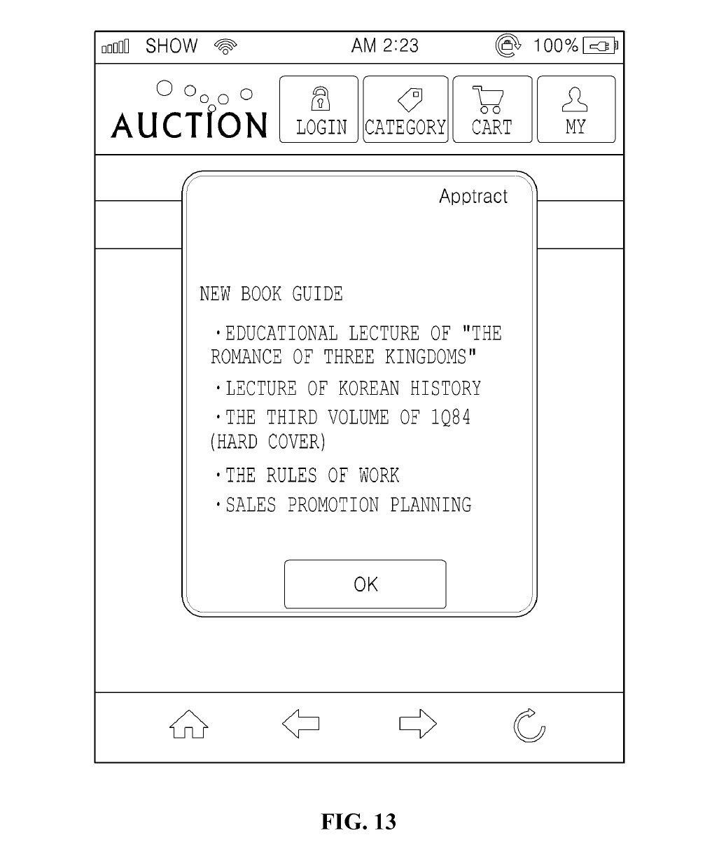

In addition, as shown in FIG. 13, the application service information includes information about the category of the application frequently used by the device 10, as a result of having analyzed the log data of the previously installed application insertion module 100. The category may be implemented as one of books, infants, education, performance and shopping, but the present invention is not limited to this category.

Meanwhile, the log data analysis DB 260 stores and manages a plurality of pieces of log data, received from the log data reception module 210, for each piece of device information. Further, the log data analysis DB 260 stores and manages the log data usage pattern information, the log data execution function information, and the log data device information, which are respectively received from the usage pattern analysis module 220, the execution function analysis module 230, and the device analysis module 240. Furthermore, the log data analysis DB also stores and manages the analysis results of the respective log data lists and the pieces of application service information, which are received from the analysis information control module 250.

The service information transmission module 270 transmits the application service information received from the analysis information control module 250 to the device 10, in which the application insertion module 100 is installed, in the form of either of pop-up and push notifications via the wireless communication network.

In this case, the service information transmission module 270 may transmit the application service information to the service data reception module 110 provided in the application insertion module 100 of the device 10 by using two methods.

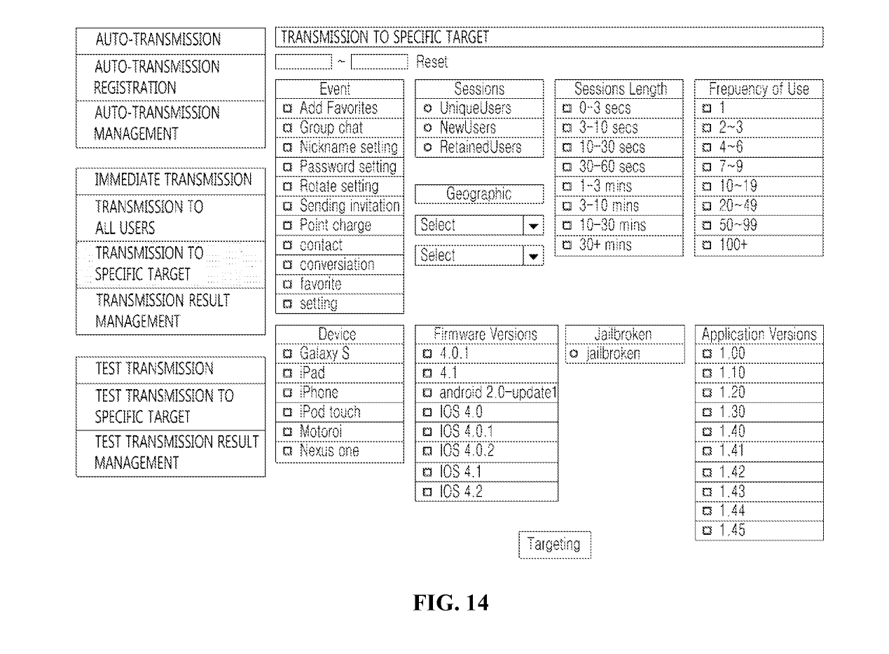

First, there is a method in which the service information transmission module 270 automatically transmits the application service information to the application insertion module 100 of the device 10 which fulfills preset conditions. Second, there is a method in which, as shown in FIG. 14, the application service information generated by the analysis information control module 250 of the analysis server 200 is transmitted to the application insertion modules 100 of all target devices 10 or the application insertion module 100 of a specific target device 10 according to the manipulation of a manager.

The transmission of application service information based on the selection of a specific target device will be described in detail below with reference to FIG. 14 by way of example.

The service information transmission module 270 may take any of the following actions according to the manipulation of the manager: an action based on the number of executions of the application (e.g., by sending a charged version invitation message to a user who executed the application three or more times during the overall period, in the form of a pop-up notification), an action based on the execution time of the application (e.g., by sending a message inviting a relevant user to reuse in the form of a pop-up notification when 15 or more days have passed since the user last executed the application), an action based on the specific behavior of the user (e.g., by sending an event message related to the addition of a favorite friend in the form of a pop-up notification to a user who runs a ‘favorite friend registration’ menu on the application during the overall period), and an action based on information about the region of use (e.g., by sending a Coex Mall coupon issuance message in the form of a pop-up notification to a user who has executed the application in Gangnam-gu during a period ranging from Aug. 1, 2010 to Sep. 30, 2010). However, the present invention is not limited to this example, and a target for the transmission of the application service information may be changed depending on the analysis of the log data.

Meanwhile, the analysis information display module 280 displays any one of the log data, the log data usage pattern information, the log data execution function information, the log data device information, the analysis results of respective log data lists, and the application service information, which are received from the analysis information control module 250.

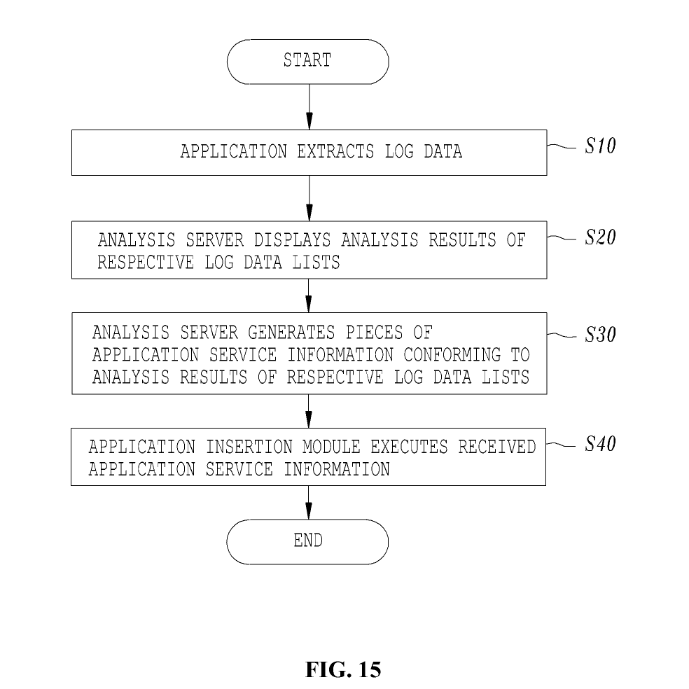

Hereinafter, a method of providing service information corresponding to mobile application analysis according to the present invention will be described in detail with reference to FIG. 15.

First, log data generated by the execution of the application insertion module 100 installed in the device 10 is extracted, and is then transmitted to the analysis server 200 over a wireless communication network at step S10.

Next, the analysis server 200 extracts usage pattern information, the execution function usage frequency information, and device information of the application, which are included in the log data received by the analysis server 200, and then displays the analysis results of the respective log data lists at step S20.

Thereafter, the analysis server 200 transmits pieces of application service information, generated to conform to the analysis results of the respective log data lists, to the application insertion module 100 installed in the device 10 over the wireless communication network in the form of a pop-up or push notification at step S30.

Further, the application insertion module 100 executes the application service information received from the analysis server 200 at step S40.

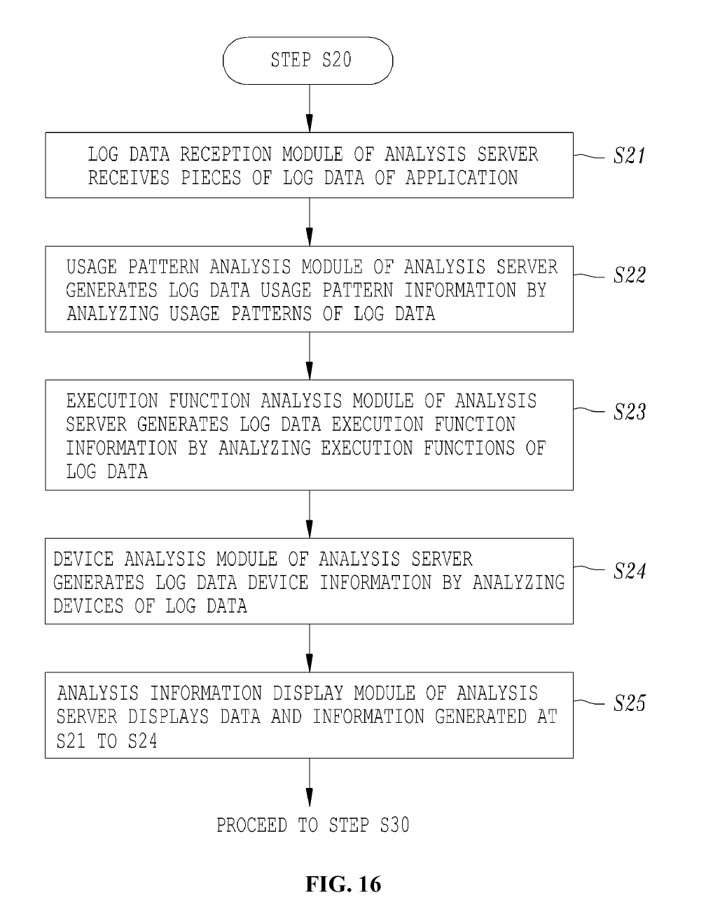

Meanwhile, the detailed procedure of step S20 in the method of providing service information corresponding to mobile application analysis according to the present invention will be described below with reference to FIG. 16.

First, the log data reception module 210 of the analysis server 200 receives pieces of log data over the wireless communication network either at preset time intervals or according to the schedule of the application insertion module 100 at step S21.

Then, the usage pattern analysis module 220 of the analysis server 200 generates log data usage pattern information by analyzing usage patterns included in the respective pieces of log data at step S22.

Thereafter, the execution function analysis module 230 of the analysis server 200 generates log data execution function information by extracting the respective pieces of log data and analyzing the details of the execution of functions or menus performed by the application at step S23.

Next, the device analysis module 240 of the analysis server 200 generates log data device information by analyzing pieces of device data included in the respective pieces of log data at step S24.

Further, the analysis information display module 280 of the analysis server 200 displays any one of the log data, the log data usage pattern information, the log data execution function information, the log data device information, the analysis results of the respective log data lists, and the application service information at step S25.

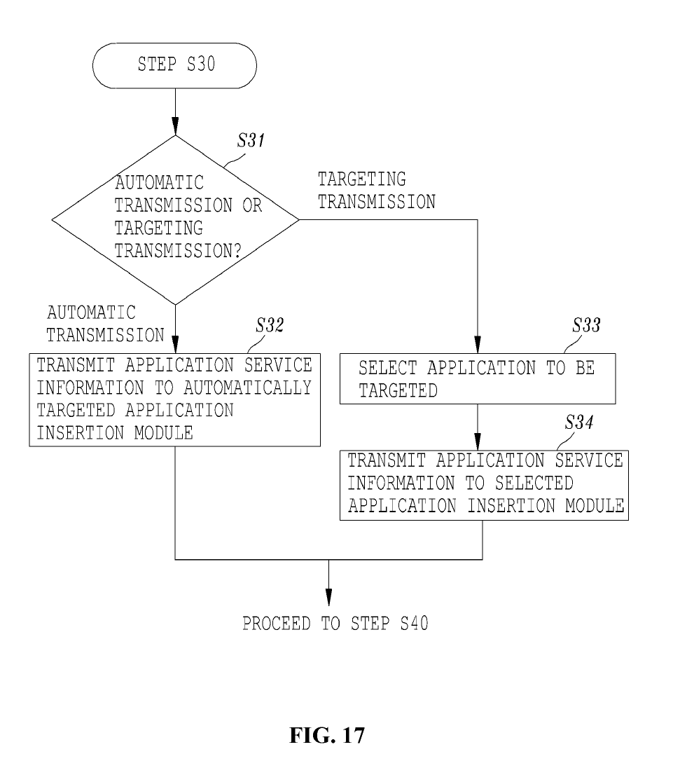

Next, the detailed procedure of step S30 of the method of providing service information corresponding to mobile application analysis according to the present invention will be described with reference to FIG. 17.

The service information transmission module 270 of the analysis server 200 determines whether to automatically transmit the application service information to the application insertion module 100 installed in the device 10, or to designate a specific target and transmit the application service information to the specific target at step S31.

Preferably, it should be understood that the automatic transmission of the application service information is to allow the analysis server 200 to periodically designate a target depending on whether there is a device 10 or an application fulfilling preset conditions and to transmit the application service information to a targeted application insertion module 100, that is, to periodically and automatically perform transmission when the preset conditions are fulfilled, without manually performing transmission by a person in every case. Further, preferably, it should be understood that a task for selecting applications to be installed in relevant devices 10 while selecting the devices 10 is performed prior to the transmission of the application service information.

If it is determined at step S31 that the transmission is to be automatically performed, the service information transmission module 270 transmits the application service information to the application insertion module 100, which has been automatically targeted based on the result of the determination, over the wireless communication network in the form of a pop-up or push notification at step S32.

Meanwhile, if it is determined at step S31 that a specific target is to be designated and transmission to the specific target is to be performed, the service information transmission module 270 selects an application, which is to be targeted and is input from the manager at step S33.

Further, the service information transmission module 270 transmits the application service information to the application insertion module 100 installed in the selected device 10 over the wireless communication network in the form of a pop-up or push notification at step S34.

That is, in the cases of both automatic transmission and input by the manager, targeting tasks (extracting only a device and an application fulfilling conditions) are performed in the same manner, and the service information is transmitted only to the device or the application.

According to the present invention, there are advantages in that the apparatus and method extracts log data generated by the execution of distributed mobile applications, analyzes the usage patterns, user behavior, device information and analysis reports of consumers, and performs targeting classification of the distributed mobile applications, thus providing required service information (information about coupons for respective regions to which devices are connected, information about the re-installation of an upgraded application, information about charging fees for a relevant application, messages inviting the reuse of a relevant application, or information about discount coupons of stores adjacent to a region which is frequently connected) to each device or application in the form of a pop-up or push notification.

As described above, although the preferred embodiments of the present invention for exemplifying the technical spirit thereof have been disclosed for illustrative purposes, those skilled in the art will appreciate that the present invention is not limited by the construction and operation illustrated and described in the above embodiments, and various modifications and changes are possible, without departing from the spirit and scope of the invention. Therefore, it should be understood that all suitable modifications and changes and equivalents thereof belong to the scope of the present invention.

What is claimed is:

1. A system for providing service information corresponding to mobile application analysis, comprising:
an application insertion module stored in a device previously distributed and installed, and configured to extract a plurality of pieces of log data generated by execution of an application of the device, transmit the pieces of extracted log data to an analysis server over a wireless communication network, and execute application service information received from the analysis server; and
the analysis server configured to receive the pieces of log data from the application insertion module, extract usage patterns, execution function usage frequency, and device information of the application, which are contained in the log data, display analysis results of respective log data lists, and transmit pieces of application service information, which are generated to conform to the analysis results of the respective log data lists, to the application insertion module installed in the device.

2. The system according to claim 1, wherein the application insertion module comprises:
a log data extraction module for extracting the pieces of log data generated in real time by the execution of the application of the device;
a log data transmission module for transmitting the pieces of extracted log data to the analysis server over a wireless communication network;
a service data reception module for receiving the application service information from the analysis server in a form of a pop-up or push notification; and
a service data execution module for executing the application service information under control of the device, and then updating the previously installed application.

3. The system according to claim 1, wherein the analysis server comprises:
a log data reception module for receiving the log data over the wireless communication network either at preset time intervals or according to a schedule of the application;
a usage pattern analysis module for generating log data usage pattern information by analyzing usage patterns contained in the log data, and storing the generated log data usage pattern information in a log data analysis database (DB);
an execution function analysis module for generating log data execution function information by analyzing details of execution of functions or menus, which are contained in the log data and are performed by the application, and storing the generated log data execution function information in the log data analysis DB;
a device analysis module for generating log data device information by analyzing pieces of device data contained in the log data, and storing the generated log data device information in the log data analysis DB; and
an analysis information control module for combining the log data usage pattern information, the log data execution function information and the log data device information, and then generating pieces of application service information corresponding to analysis results of respective log data lists.

4. The system according to claim 3, wherein the log data usage pattern information comprises at least one of information about a count of a number of executions of the application, information about a count of users obtained by eliminating a number of duplicated sessions based on date, information about a count of new users, information about a count of retained users, information about usage frequency based on the number of executions of the application, information about a count of an average number of executions for each unique user, and information about region-based user distributions.

5. The system according to claim 3, wherein the log data execution function information comprises information about a count of a number of executions of the application for each menu, and data changed by the execution of the application installed in the device.

6. The system according to claim 3, wherein the log data device information comprises information about a count of model-based devices in which the application is installed, information about a framework of an operating system installed to operate the devices, information about a count of version-based applications installed in the devices, and information about a count of models, in which security of the application is released and jailbroken, for each device.

7. The system according to claim 1, wherein the pieces of application service information comprise information required to upgrade a version of the application previously installed in the device, information required to provide notification of error information of the application, information about details of a newly released application, and information about provision of coupons for respective regions to which the device on which the application is executed is connected.

8. The system according to claim 1, wherein the analysis server comprises:
a log data analysis DB for storing and managing the pieces of log data for pieces of device information, and storing and managing log data usage pattern information, log data execution function information, log data device information, the analysis results of respective log data lists, and the application service information;
a service information transmission module for transmitting the application service information to the application insertion module installed in the device in a form of a pop-up or push notification via the wireless communication network; and
an analysis information display module for displaying any one of the log data, the log data usage pattern information, the log data execution function information, the log data device information, the analysis results of respective log data lists, and the application service information.

9. A method of providing service information corresponding to mobile application analysis, comprising:
(a) an application insertion module extracting log data generated by execution of an application installed on a device, and transmitting the extracted log data to an analysis server over a wireless communication network;
(b) the analysis server extracting usage patterns, execution function usage frequency, and device information of the application, which are contained in the received log data, and then displaying analysis results of respective log data lists;
(c) the analysis server transmitting pieces of application service information, which are generated to conform to the analysis results of respective log data lists, to the application insertion module installed in the device over the wireless communication network in a form of a pop-up or push notification; and
(d) the application insertion module executing the application service information received from the analysis server.

10. The method according to claim 9, wherein (b) comprises:
(b-1) a log data reception module of the analysis server receiving the pieces of log data over the wireless communication network either at preset time intervals or according to a schedule of the application;
(b-2) a usage pattern analysis module of the analysis server generating log data usage pattern information by analyzing the usage patterns contained in the respective pieces of log data;
(b-3) an execution function analysis module of the analysis server generating log data execution function information by analyzing details of execution of functions or menus, which are performed by the application and are included in the respective pieces of log data;
(b-4) a device analysis module of the analysis server generating log data device information by analyzing pieces of device data contained in the respective pieces of log data; and
(b-5) an analysis information display module of the analysis server displaying any one of the log data, the log data usage pattern information, the log data execution function information, the log data device information, the analysis results of respective log data lists, and the application service information.

11. The method according to claim 9, wherein (c) comprises:
(c-1) a service information transmission module of the analysis server determining whether to automatically transmit the application service information to the application insertion module installed in the device, or to designate a specific target and transmit the application service information to the specific target;
(c-2) if, as a result of determination at (c-1), the application service information is to be automatically transmitted, the service information transmission module transmitting the application service information to an application insertion module, which has been automatically targeted as the result of the determination, in a form of a pop-up or push notification over the wireless communication network;
(c-3) if, as the result of determination at step (c-1), the specific target is to be designated and the application service information is to be transmitted thereto, the service information transmission module selecting an application to be targeted, which has been input from a manager; and
(c-4), after (c-3), the service information transmission module transmitting the application service information to an application insertion module installed in a selected device in a form of a pop-up or push notification over the wireless communication network.
